(19) United States
(12) Patent Application Publication
(10) Pub. No.: US 2016/0188749 A1
(43) Pub. Date: Jun. 30, 2016

(54) Feed Data Storage and Query

(71) Applicant: Alibaba Group Holding Limited, Grand Cayman (KY)

(72) Inventors: Xiaojin Ning, Hangzhou (CN); Xiliang Zhou, Hangzhou (CN)

(21) Appl. No.: 14/984,251

(22) Filed: Dec. 30, 2015

(30) Foreign Application Priority Data
Dec. 31, 2014 (CN) 201410855934.3

(51) Int. Cl. G06F 17/30

(52) U.S. Cl. CPC G06F 17/30958; G06F 17/30979; G06F 17/30991

(57) ABSTRACT

Methods and devices for storing and querying feed data. A method includes generating, by a computing device, multiple shards from feed data of an individual user. An individual shard may include first data, second data and third data. The computing device may thereby form a linked list structure of the multiple shards, and store the individual shard in a storage system. When the user sends a query for feed data, the computing device may obtain a unique identifier from the query, and search the storage system using the unique identifier. The computing device may then determine the current shard based on the unique identifier in the storage system and an additional shard corresponding to the third data of the current shard. The computing device may return the first data and second data of the additional shard to the user.

### CROSS REFERENCE TO RELATED PATENT APPLICATIONS

This application claims priority to Chinese Patent Application No. 201410855934.3, filed on Dec. 31, 2015, entitled “Methods and devices for feed data storage and query,” which is hereby incorporated by reference in its entirety.

### TECHNICAL FIELD

The present disclosure relates to data storage and query, and particularly to a method and an apparatus for storing and querying feed data.

### BACKGROUND

Feed data is a form of data and corresponds to an information source or source material, such as feeding, provision of information, feeds, abstracts, sources, news feeds, web sources, etc. Websites may deliver the latest information to users using this data format. A criterion for users to be able to subscribe to a website is that the website is able to provide continually updated information to the users. As blogs and news sites frequently update content thereof, information sources are widely adopted by these types of websites.

After client terminals access servers, feed streams may be shown as data sorted based on a time line. In other words, data returned from the server must be greater than data of a previous time of request, similar to situations in microblog and Twitter, for example. Due to the popularity of microblog and Twitter, feed stream based rendering has become more and more popular. Feed stream based rendering allows users to see the latest feed data, and therefore improves user experience.

Feed stream based rendering has advantages in mobile communications. In conventional PC devices, a mouse and a keyboard are primary means of inputs. With respect to mobile devices, a primary means of input becomes users' gestures on a touch screen. Screen sizes of mobile devices determine a scope of gestures and actions that cannot be diversified too much. For example, drag-up, drag-up, drag-left, drag-right become the most efficient gestures. Feed stream based rendering is implemented using simple gestures such as a drag-up and a drag-down to query the latest feed data and feed data that has been read. For example, a user may use a mobile device (which may run an IOS® or Android® operating system) to access a server port via http (i.e., Hypertext Transfer Protocol). When the user opens a page, the user may perform a drag-down gesture to query “unread” feed data and a drag-up gesture to query “read” feed data.

Conventional techniques include Redis and related feed index table caches. Redis was developed by Italian programmer Salvatore Sanfilippo (Antirez) as early as 2009, and is an open source which supports networks and memory-based key-value pair (key-value) storage database and is programmed using ANSI C. A key that is stored is an identifier of a user, and a value corresponding thereto is a FeedId set of the user. When a user accesses a port of a server, the server first finds a FeedId set from Redis based on an identifier of the user, and locates a certain offset in the FeedId set from which a segment is to be obtained via a sorting algorithm. Feed content corresponding to the FeedId set may be determined and obtained from a query relational database after obtaining the segment of the FeedId set, and data is returned to an associated client.

The conventional techniques described above have the following disadvantages. First, cache data which is returned and queried has a low utilization rate. A key-value distributed cache system stores a respective FeedId data set for each user, and the entire FeedId set needs to be found from a distributed cache system for each query. However, only a small portion of the FeedId set is used in reality after computation. This wastes a lot of network bandwidth and increase query response time.

Secondly, a query path for content links of feed data is long. During the process between receiving a request from a client terminal and returning feed content data to the client terminal, at least two network requests have to be initialized. In a first request, a FeedId set is found from a key-value distributed cache system using a user identifier. In a second request, a query is made to a relational database based on the found FeedId, and feed content corresponding to the FeedId is obtained and returned to the client terminal.

Finally, these techniques do not support querying “read feed” data. While supporting queries for the latest Feed, these techniques do not support queries for “read feed” data in a server. Therefore, users can only locally read Feed data that is found in response to a previous query.

### SUMMARY

Implementations herein relate to methods and devices for storing and querying feed data. Feed data may be stored in the form of shards in a storage system. This reduces the number of queries hitting feed content data, improves the system efficiency for read and write capabilities of small data blocks, reduces server response time, and improves efficiency. This Summary is not intended to identify all key features or essential features of the claimed subject matter, nor is it intended to be used alone as an aid in determining the scope of the claimed subject matter.

The implementations relate to a method for storing and querying feed data. Feed data may be stored in the form of shards in a storage system. Each shard includes data and an identifier of the respective shard, and an identifier of a next shard. The method may include generating, by a computing device, multiple shards from feed data of an individual user. In these instances, an individual shard may include first data, second data and third data. The first data may include a predetermined amount of feed data, the second data may include a unique identifier of the individual shard, and the third data may include a unique identifier of a next shard after the individual shard. The computing device may then form a linked list structure connecting the multiple shards with one another, and store the shards in a storage system.

In implementations, the computing device may then receive a query for feed data from a user, obtain a unique identifier of a current shard from the query, and search the storage system using the unique identifier as a key word. The computing device may then return first data and second data of a shard that is stored in the storage system and is pointed by third data of the current shard in which second data matching the key word is located to the user.

The implementations also relate to another method for storing and querying feed data. The method may include generating, by a computing device, multiple shards from feed data of an individual user. An individual shard may include first data, second data and third data. The first data may include a predetermined amount of feed data, the second data may include a unique identifier of the individual shard, and the third data may include a unique identifier of a previous shard before the individual shard. The computing device may form a list structure linking the multiple shards, and store the shards in a storage system.

In implementations, the computing device may then receive a query for feed data from a user, obtaining a unique identifier of a current shard from the query, and perform a search in the storage system using the unique identifier as a key word. The computing device may then determine the current shard from the storage system based on the unique identifier, and an additional shard corresponding to third data of the current shard. The computing device may return first data and second data of the additional shard to the user.

The implementations also relate to a device for storing and querying feed data. The device may include a sharding module configured to generate multiple shards from feed data of an individual user. An individual shard including first data, second data and third data. The first data may include a predetermined amount of feed data, the second data may include a unique identifier of the individual shard, and the third data may include a unique identifier of a next shard following the individual shard. The sharding module further forms a linked list structure connecting the multiple shards. The device may further include a storage module configured to store the multiple shards in a storage system. The device may further include a query module configured to receive a query for feed data from a user, obtain a unique identifier of a current shard from the query, and search the storage system using the unique identifier as a key word. The device may further include a returning module configured to determine the current shard from the storage system based on the unique identifier, determine an additional shard corresponding to third data of the current shard, and return first data and second data of the additional shard to the user.

The implementations also relate to another device for storing and querying feed data. The device may include a sharding module configured to generate multiple shards from feed data of an individual user. An individual shard including first data, second data and third data. The first data may include a predetermined amount of feed data, the second data may include a unique identifier of the individual shard, the third data may include a unique identifier of a previous shard preceding the individual shard. The sharding module may further form a linked list structure connecting the multiple shards. The device may further include a storage module configured to store the multiple shards in a storage system. The device may further include a query module configured to receive a query for feed data from a user, obtain a unique identifier of a current shard from the query, and search the storage system using the unique identifier as a key word. The device may further include a returning module configured to return first data and second data of a shard that is stored in the storage system and is pointed by third data of the current shard in which second data matching the key word is located to the user.

Compared with existing technologies, one aspect of the present application has the following advantages. The implementations include dividing feed data into multiple shards based on a predetermined amount value. Each shard of feed data is stored individually in a form of a linked list structure. Each query only needs to query a shard of data blocks without querying the entire linked list structure. This effectively reduces query response time.

Further, the implementations adopt a distributed storage system. Compared with other existing distributed storage systems, a distributed storage system has a greater stability and is more powerful. Further, the implementations use a read feed list structure and a unread feed list structure to realize querying read feed data and to improve user experience.

### BRIEF DESCRIPTION OF THE DRAWINGS

The Detailed Description is described with reference to the accompanying figures. The use of the same reference numbers in different figures indicates similar or identical items.

FIG. 1 is a schematic flow diagram illustrating a method for storing and querying feed data in the embodiments of the present disclosure.

FIG. 2 is a block diagram illustrating feed data block structure in the embodiments of the present disclosure.

FIGS. 3, 4 and 5 are schematic diagrams illustrating examples of the embodiments of the present disclosure.

FIG. 6 is a schematic diagram illustrating a device for storing and querying feed data in the embodiments of the present disclosure.

### DETAILED DESCRIPTION

The present disclosure includes a number of technical details to enable readers to have better understanding. However, one of ordinary skill in the art can understand that the claimed technical solution sought to be protected by appended claims of the present disclosure can be achieved even without these technical details and various changes and modifications to the following embodiments.

To make the technical solutions and advantages more apparent, the following examples of specific embodiments in connection with the present application and the accompanying drawings are clearly and completely described herein.

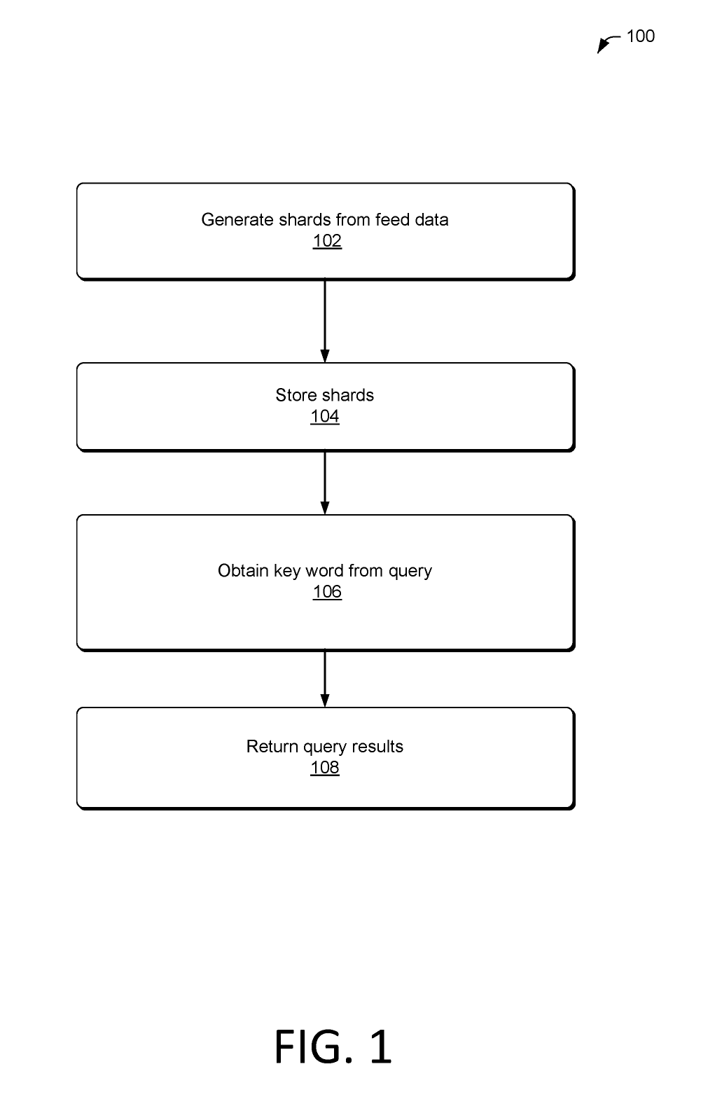

The implementations relate to a method for storing and querying feed data. FIG. 1 is a schematic flow diagram illustrating a method for storing and querying feed data in the first embodiment of the present disclosure. The method includes dividing feed data into multiple shards based on a predetermined amount value. The multiple shards of the feed data are individually stored in a form of a linked list structure.

As illustrated in FIG. 1, the method may include the following operations. At 102, a computing device (e.g., a server) may generate multiple shards from feed data of an individual user. In these instances, an individual shard includes first data, second data and third data. The first data includes a predetermined amount of feed data, the second data includes a unique identifier of the individual shard, and the third data includes a unique identifier of a shard next to the individual shard. Accordingly, a linked list structure that connects the multiple shards with one another is thus formed.

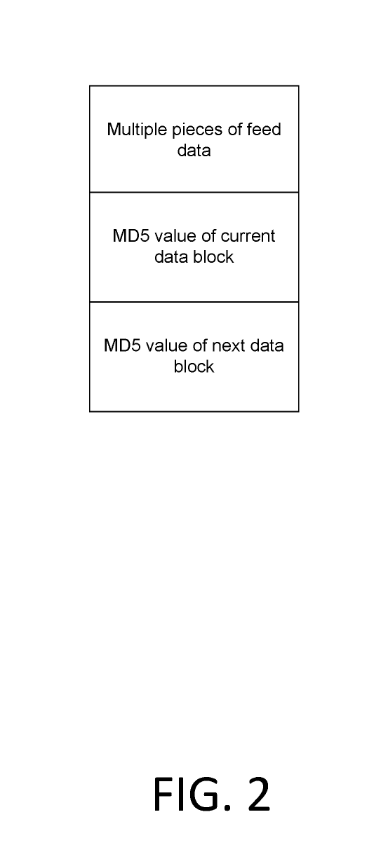

FIG. 2 is a block diagram illustrating a feed data block structure in the first embodiment of the present disclosure. As illustrated in FIG. 2, a shard (a data block) includes first data, second data and third data. The first data includes multiple pieces of feed data, with the number of pieces forming the feed data in the first data being predetermined. The second data includes a unique identifier of the current shard (or data block). The third data includes a unique identifier of a shard next to the current shard. Therefore, the next shard (data block) may be determined using this unique identifier of the third data.

Since third data of each shard can be used to determine a next shard, a linked list structure is therefore formed. The unique identifier may include various types of identifiers such as a Message-Digest Algorithm 5 (MD5) value, an AES value, a SHA value, etc. As illustrated in FIG. 2, the unique identifier is a MD5 value. MD5 is known as the message digest algorithm fifth edition, and allows large-capacity information to be compressed into a confidential format (e.g., a byte string of arbitrary length is converted into a hex numeric string of a certain length).

At 104, the computing device may store the multiple shards in a storage system. The storage system is a key-value distributed storage system or other distributed storage system. The key value distributed storage system is a distributed storage system (e.g., Tair distributed storage system and a Redis distributed storage system). Pair here refers to a key pair (key-value). Tair distributed storage system is Taobao Pair distributed storage system, which was created by Taobao company as an open source key-value cache system, including two storage functions: caching and persistence.

As compared with Redis system and other existing systems, Tair has more functions, higher throughput, and higher stability. For example, unlike a Redis system, a Tair system has functions such as cross-room management, multi-cluster management, copying functions, etc. The Redis system has a throughput capacity of 60,000 times per second, and the Tair system's throughput is 66,000 per second, which is 10% more than those of Redis system. The Redis system has been used in websites such as Baidu, Sina, Tencent, Sohu and Twitter, etc., and has been a cause of failures in Weibo. The Tair system has a huge number of daily visits while still maintaining stable performance.

At 106, the computing device may receive a query for feed data from a user, obtain a unique identifier of a current shard from the query, and search the storage system using the unique identifier as a key word. For example, if the unique identifier is a MD5 value, the computing device may search the storage system using the MD5 value as a key word.

At 108, the computing device may determine the current shard based on the unique identifier in the storage system and an additional shard corresponding to third data of the current shard, and return first data and second data of the additional shard to the user. For example, the computing device may return first data and second data of a shard that is stored in the storage system and is pointed by third data of the current shard in which second data matching the key word is located to the user.

Using the MD5 value, the computing device may determine a corresponding shard (data block) in the storage system. For example, the computing device may determine whether the second data of the corresponding shard matches the key word. The third data of the corresponding shard points to a next shard of the corresponding shard. The computing device may return feed data and a unique identifier of the next shard as a search result to the user.

After the user receives the search result, the next shard's unique identifier (i.e., the second data) is considered as one of the input parameters for the next query. Using third data of the next shard, the computing device may obtain feed data and a unique identifier of another shard that is next thereto. Accordingly, feed data and a unique identifier of each shard of the linked list structure may be obtained.

The computing device may generate multiple shards from feed data based on a predetermined amount value. The shards of the feed data are stored separately in a form of a linked list structure. Each query only needs to query a shard of data blocks without querying the entire linked list structure. This effectively reduces query response time.

The list structure may be implemented using any list structures, for example, a read feed list and an unread feed list. This type of list structure realizes querying read feed data and improves user experience. The conversion between these two feed lists may be implemented in various ways. For example, a shard in an unread feed list may be added to a read feed list after the shard has been queried.

A user may send a query at a first time and the query may not include an input parameter of a shard. Since the computing device cannot obtain a unique identifier of the shard, the computing device may return first data and second data of a shard on a head of unread feed list to the user.

In implementations, the read feed list and the unread feed list may or may not have length limits. In an event that length limits exist, the computing device may delete a shard on a tail of the read feed list and add a new shard to the head of the read feed list in response to a determination that a length of the read feed list reaches a length limit of the read feed list. The computing device may delete a shard on the head of the unread feed list and add a new chard to the tail of the unread feed list in response to a determination that a length of the unread feed list reaches a length limit of the unread feed list.

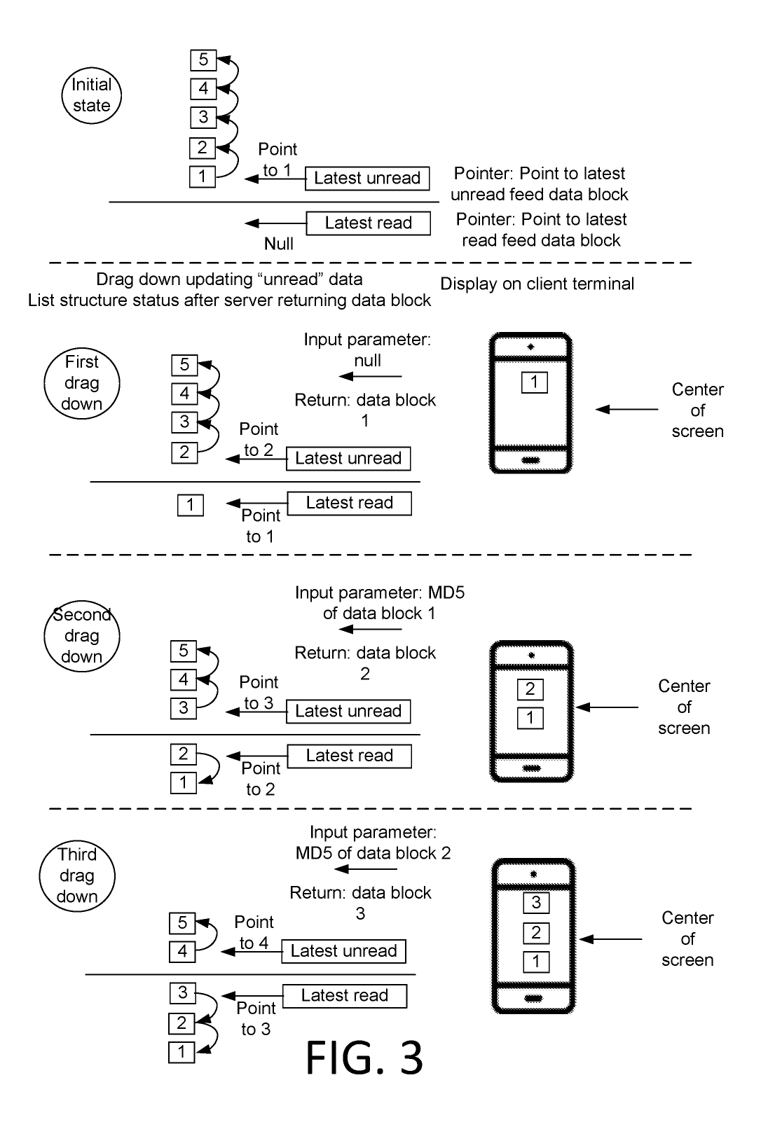

FIG. 3 is schematic diagram illustrating an example of the first embodiment of the present disclosure. As shown in FIG. 3, suppose that there are 5 shards (data blocks) initially, and all of them are in an unread feed list. Accordingly, the computing device may set the read feed list as null. Further, the computing device may set two pointers: a latest read pointer pointing to a feed shard (data block) that is latest read. Since the read feed list is null, the pointer points to null. Further, a latest unread pointer points to the latest unread feed shard. Accordingly, this pointer points to number 1 shard on a head of the unread feed list.

As shown in FIG. 3, in the first drag-down, input parameters from a user is null. The computing device may return a shard on the head of the unread feed list (i.e., the first data of the number 1 shard and the second data) to the user. The first data includes the data block 1 (i.e., multiple pieces of feed data of the number 1 shard). The second data includes the MD5 value of the data block 1 (i.e., the unique identifier of the number 1 shard).

The computing device may cause or provide the first data of the number 1 shard to display on a display of the client terminal of the user. Further, the computing device may change the positions of the two pointers and shards included in the two feed lists. Since the user has queried the number 1 shard, the computing device may delete the number 1 shard from the unread feed list. The number 1 shard is added to the read feed list and will belong to the read feed list after the change. Number 2 to number 5 shards still belong to the unread feed list. Accordingly, the latest read pointer points to the number 1 shard instead of null. The latest unread pointer points to the number 2 shard instead of the number 1 shard.

As shown in FIG. 3, during the second drag-down, the user's input parameters include the MD5 value of data block 1. Accordingly, the computing device may perform a query using the MD5 value of the data block 1. The computing device may return a shard having the second data matching the MD5 value of the data block 1 to the user. For example, the computing device may return the third data of the shard (i.e., the MD5 value of the number 2 shard) and the first data as well as the second data (i.e., the unique identifier) of the number 2 shard to the user.

The computing device may cause or provide the first data of the number 1 shard and the first data of the number 2 shard to display on the display of the client terminal of the user. Further, the computing device may change the positions of the two pointers and the shards included in the two feed lists. Since the user has queried the number 2 shard, the computing device may delete the number 2 shard from the unread feed list. The number 2 shard is added to the read feed list. After the change, the number 1 and 2 shards belong to the read feed list. Accordingly, the latest read pointer changes from pointing to the number 1 shard to pointing to the number 2 shard. The latest unread pointer points to the number 3 shard instead of the number 2 shard.

As shown in FIG. 3, during the third drag-down, the user's input parameters include the MD5 value of data block 2. Accordingly, the computing device may perform a query using the MD5 value of the data block 2.

The computing device may return a shard having the second data matching the MD5 value of the data block 2 to the user. For example, the computing device may return the third data of the shard (i.e., the MD5 value of the number 3 shard) and the first data as well as the second data (i.e., the unique identifier) of the number 3 shard to the user.

The computing device may cause or provide the first data of the number 2 shard and the first data of the number 3 shard to display on the display of the client terminal of the user. Further, the computing device may change the positions of the two pointers and the shards of the two feed lists. Since the user has queried the number 3 shard, the computing device may delete the number 3 shard from the unread feed list.

The number 3 shard is added to the read feed list. After the change, the number 1 to the number 3 shards belong to the read feed list, and the number 4 and 5 shards still belong to the unread feed list. Accordingly, the latest read pointer points to the number 3 shard instead of the number 2 shard. The latest unread pointer points to the number 4 shard instead of the number 3 shard. In this case, the user does not continue to query.

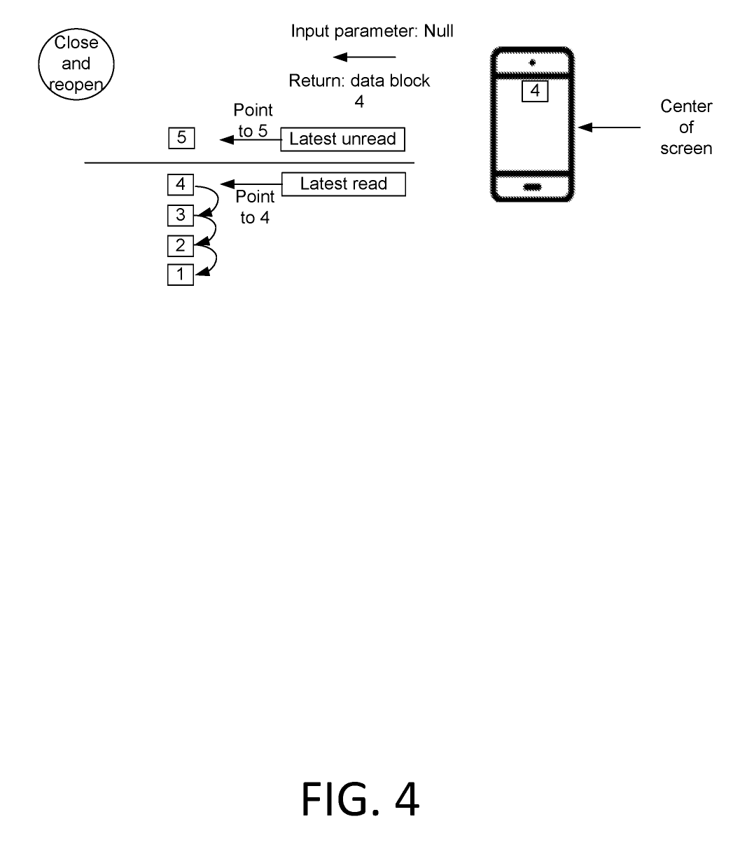

After a certain amount of time, the user restarts to query as illustrated in FIG. 4. When a user stops querying and then resumes querying, a drag-down list will automatically appear. The input parameters from the user are null. The computing device may return a shard on the head of the unread feed list (i.e., the first data of the number 4 shard and the second data) to the user. The first data includes the data block 4 (i.e., multiple pieces of feed data of the number 4 shard). The second data includes the MD5 value of the data block 4 (i.e., the unique identifier of the number 4 shard).

The computing device may cause or provide the first data of the number 4 shard to display on the display of the client terminal of the user. Further, the computing device may change the positions of the two pointers and shards of the two feed lists. Since the user has queried the number 4 shard, the computing device may delete the number 4 shard from the unread feed list. The number 4 shard is added to the read feed list. After the change, the number 1 to 4 shards belong to the read feed list, and the number 5 shard still belong to the unread feed list. Accordingly, the latest read pointer changes from pointing to the number 3 shard to pointing to the number 4 shard. The latest unread pointer changes from pointing to the number 4 shard to pointing to the number 5 shard. Thereafter, each drag-down operation is similar to those described above.

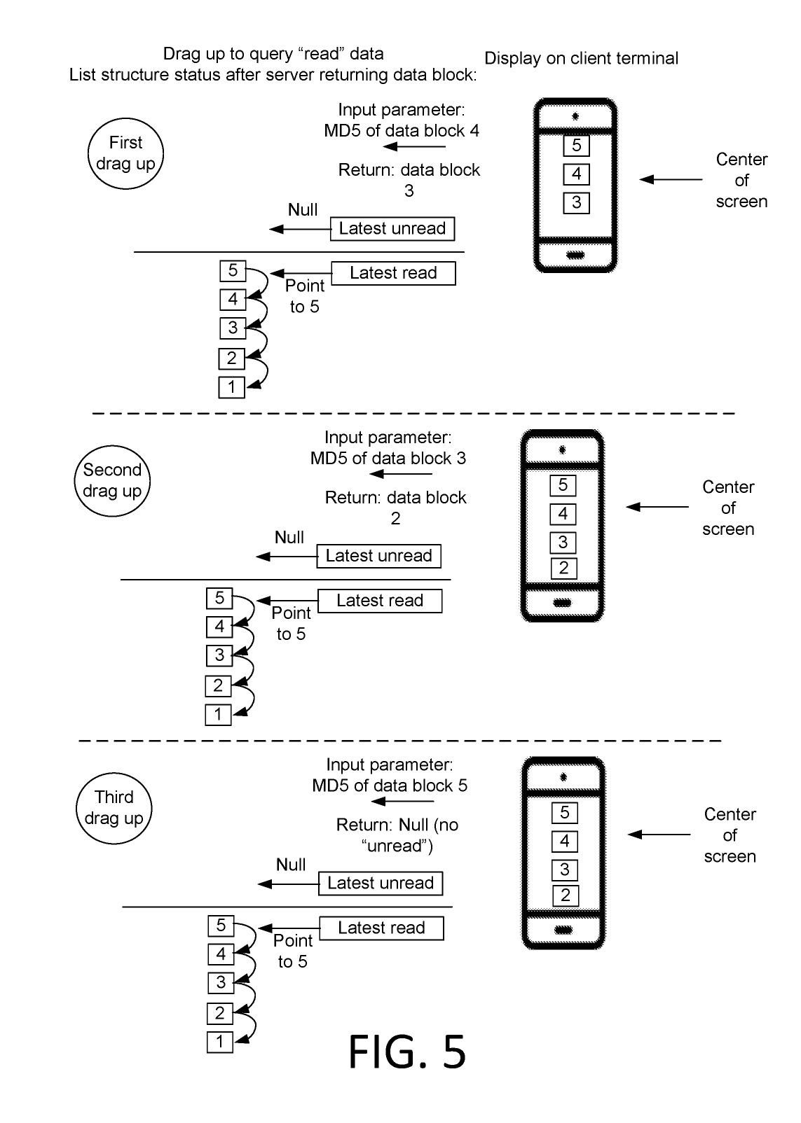

FIG. 5 shows scenario of a drag-up query for read data. Since drag-up and drag-down are operations opposite to each other, the drag-up operations are performed in an opposite way of those described for drag-down operations. Examples described above may be implemented by a user querying from multiple client terminals such as mobile phones, tablet PCs, and home computer.

The computing device may obtain a unique identifier of a shard for the data block that the user read in a previous time at a client terminal. Therefore, the computing device may correctly determine the next shard and return the first data and the second data to the client terminal. Each method embodiment of the present disclosure may be implemented in software, hardware, firmware, etc.

Regardless of whether the present disclosure is based on software, hardware, or firmware ways, instruction code can be stored in any type of computer memory that can be accessed (such as permanent or non permanent, volatile or non-volatile, solid-state or non-solid, predetermined or interchangeable media, etc.).

Similarly, the memory may be, for example, a Programmable Array Logic (PAL), a random access memory (RAM), programmable read-only memories (PROM), read only memory (ROM), electrically erasable programmable read-only memory (EEPROM), disk, optical disc, digital versatile disc (DVD) and the like.

The implementations relate to another method for storing and querying feed data. This embodiment is substantially similar to the first embodiment. In the first embodiment, the third data is a unique identifier of a next shard that is after the current shard. In this embodiment, the third data is a unique identifier of a previous shard that is before the current shard. The two embodiments have no further differences. Technical details of the first embodiment are also effective in this embodiment. The implementations also relate to a device for storing and querying feed data.

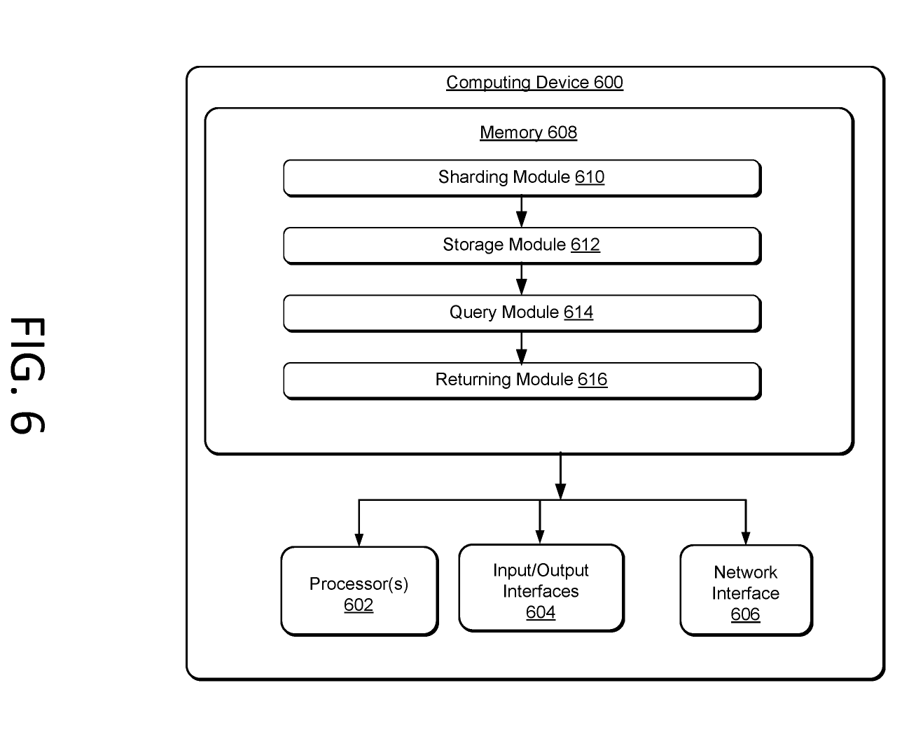

FIG. 6 is a schematic diagram illustrating a device for storing and querying feed data in the third embodiments of the present disclosure. The actual structure of the present disclosure can make the necessary adjustments based on actual needs, the structure is not limited to FIG. 6. The device may generate multiple shards from feed data based on a predetermined amount of data, and the multiple shards of the feed data are individually stored in a form of a linked list structure.

FIG. 6 is a diagram of a computing device 600. The computing device 600 may be a user device or a server for storage and query of feed data. In one exemplary configuration, the computing device 600 includes one or more processors 602, input/output interfaces 604, network interface 606, and memory 608.

The memory 608 may include computer-readable media in the form of volatile memory, such as random-access memory (RAM) and/or non-volatile memory, such as read only memory (ROM) or flash RAM. The memory 608 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. As defined herein, computer-readable media does not include transitory media such as modulated data signals and carrier waves.

Turning to the memory 608 in more detail, the memory 608 may include a sharding module 610, a storage module 612, a query module 614, and a returning module 616.

The sharding module 610 may be configured to generate multiple shards from feed data of an individual user. An individual shard may include first data, second data and third data, the first data including a predetermined amount of feed data, the second data including a unique identifier of the individual shard, and the third data including a unique identifier of a shard next to the individual shard. The sharding module 610 may thereby form a linked list structure connecting the multiple shards.

The storage module 612 may be configured to store the shards in a storage system. The query module 614 may be configured to receive a query for feed data from a user, obtain the unique identifier of a current shard from the query, and search the storage system using the unique identifier as a key word. The returning module 616 may be configured to determine the current shard based on the unique identifier in the storage system, determine an additional shard corresponding to the third data of the current shard, and return the first data and second data of the additional shard to the user. For example, the returning module 616 may return first data and second data of a shard that is stored in the storage system and is pointed by third data of the current shard in which second data matching the key word is located to the user.

The fourth embodiment relates to another device for storing and querying feed data. This embodiment is substantially similar to the third embodiment. In the previous embodiment, the third data is a unique identifier of a next shard following or after the current shard, while in this embodiment the third data is a unique identifier of a previous shard preceding or before the current shard. The two embodiments have no further differences. Technical details of the third embodiment are also effective in this embodiment.

The first embodiment and the second embodiment are method embodiments complementary to each other. The first embodiment and the second embodiment can be cooperatively implemented. Technical details of the first embodiment are also applicable to the second embodiment.

Correspondingly, technical details of the first embodiment are also applicable to the second embodiment. It should be noted that each unit is a logical unit of each device embodiments of the present disclosure. Physically, a logic unit may be implemented as a physical unit, a part of a physical unit, or a combination of physical units. The physical implementation of the logical unit itself is not the most important. Rather, the combination of these functions implemented by the logic unit is the key to solve the technical problems raised by the present disclosure. In addition, in order to highlight innovative parts of the invention, the present disclosure includes but is not limited to the modules described above.

It should be noted that, in the disclosure and claims, relational terms such as first and second, and the like are only used to distinguish one entity or the operating entity or another separate operating area, but do not necessarily require or imply an existence of any such actual relationship or order among these entities or operations.

Moreover, the term “comprising”, “including” or any other variation thereof, are intended to cover a non-exclusive inclusion, such that a series of factors including the process, method, article or device include not only those elements. But, these terms also include other elements not expressly listed or for such further comprising process, method, article, or apparatus inherent feature. In the absence of more restrictions, by the statement “includes a” defining element, does not exclude the existence of additional identical elements in the process include the elements, method, article, or apparatus.

Although the present disclosure is described using reference to certain preferred embodiments, the present disclosure has been shown and described above, and one of ordinary skill in the art should understand that forms and details may vary without departing from the spirit and scope of the present disclosure.

The embodiments are merely for illustrating the present disclosure and are not intended to limit the scope of the present disclosure. It should be understood for persons in the technical field that certain modifications and improvements may be made and should be considered under the protection of the present disclosure without departing from the principles of the present disclosure.

What is claimed is:

1. A method for storing and querying feed data, the method comprising:
generating multiple shards from feed data of one or more users, an individual shard including first data, second data and third data, the first data including a predetermined amount of feed data, the second data including a unique identifier of the individual shard, and the third data including a unique identifier of a shard next to the individual shard;
forming a linked list structure between the multiple shards;
storing the individual shard in a storage system;
receiving a query for the feed data from a user;
obtaining the unique identifier of an individual shard from the query;
searching the storage system using the unique identifier as a key word;
determining a current shard corresponding to the unique identifier in the storage system,
determining an additional shard corresponding to the third data of the current shard; and
returning the first data and second data of the additional shard to the user.

2. The method of claim 1, wherein the storage system is a key-value distributed storage system.

3. The method of claim 2, wherein the key-value distributed storage system is a distributed storage system.

4. The method of claim 1, wherein the unique identifier is a Message-Digest Algorithm 5 (MD5) value.

5. The method of claim 1, wherein the list structure includes a read feed list and a unread feed list.

6. The method of claim 5, further comprising:
deleting the current shard from the unread feed list and adding the current shard to the read feed list after the current shard in the read feed list have been queried by the user.

7. The method of claim 5, further comprising:
determining that a unique identifier of a queried shard is not available; and
returning the first data and the second data of a shard on a head of unread feed list to the users.

8. The method of claim 5, wherein each of the read feed list and the unread feed list have independent length limits, and the method further comprises:
deleting a shard on a tail of the read feed list in response to a determination that a length of the read feed list reaches a length limit of the read feed list;
adding an additional shard to a head of the read feed list;
deleting a shard on the head of the unread feed list in response to a determination that a length of the unread feed list reaches a length of the unread feed list; and
adding an additional shard to the tail of the unread feed list.

9. A method of storing and querying feed data, the method comprising:
generating multiple shards from feed data of one or more user, an individual shard including first data, second data and third data, the first data including a predetermined amount of feed data, the second data including a unique identifier of the individual shard, and the third data including a unique identifier of a previous shard of the individual shard;
forming a linked list structure between the multiple shards;
storing the individual shard in a storage system;
receiving a query for the feed data from a user;
obtaining the unique identifier of an individual shard from the query;
searching the storage system using the unique identifier as a key word;
determining a current shard based on the unique identifier in the storage system;
determining an additional shard corresponding to the third data of the current shard; and
returning the first data and second data of the additional shard to the user.

10. A device comprising:
one or more processors; and
memory to maintain a plurality of components executable by the one or more processors, the plurality of components comprising:
a sharding module configured to:
generate multiple shards from feed data of one or more users, an individual shard including first data, second data and third data, the first data including a predetermined amount of feed data, the second data including a unique identifier of the individual shard, and the third data including a unique identifier of a shard next to the individual shard or a previous shard of the individual shard, and
forming a linked list structure between the multiple shards,
a storage module configured to store the individual shard in a storage system,
a query module configured to:
receive a query for the feed data from a user,
obtain the unique identifier of an individual shard from the query, and
search the storage system using the unique identifier as a key word, and
a returning module configured to:
determine a current shard corresponding to the unique identifier in the storage system,
determine an additional shard corresponding to the third data of the current shard, and
return the first data and second data of the additional shard to the user.

11. The device of claim 10, wherein the storage system is a key-value distributed storage system.

12. The device of claim 11, wherein the key-value distributed storage system is a distributed storage system.

13. The device of claim 10, wherein the unique identifier is a MD5 value.

14. The device of claim 10, wherein the list structure includes a read feed list and an unread feed list.

15. The device of claim 14, further comprising:
deleting the current shard from the unread feed list after the current shard in the read feed list having been queried by the user; and
adding the current shard to the read feed list.

16. The device of claim 14, further comprising:
determining that a unique identifier of a queried shard is not available; and
returning the first data and the second data of a shard on a head of unread feed list to the users.

17. The device of claim 14, wherein the read feed list and the unread feed list have length limits.

18. The device of claim 17, wherein the sharding module is further configured to:
delete a shard on a tail of the read feed list in response to a determination that a length of the read feed list reaches a length limit of the read feed list; and
add an additional shard to a head of the read feed list.

19. The device of claim 17, wherein the sharding module is further configured to:
delete a shard on a head of the unread feed list in response to a determination that a length of the unread feed list reaches a length of the unread feed list; and
add an additional shard to a tail of the unread feed list.

20. The device of claim 14, wherein the current shard is convertible between the unread feed list and the read feed list.
